(19) United States
(12) Patent Application Publication
(10) Pub. No.: US 2007/0239482 A1
(43) Pub. Date: Oct. 11, 2007

(54) Vision Based Data Acquisition System and Method For Acquiring Medical and Other Information

(75) Inventors: Joseph T. Finn, Kennett Sq., PA (US); Murray Malin, Bethesda, MD (US); Arnold Rudorfer, Princeton, NJ (US); Xiping Song, Cranbury, NJ (US); Matthias Voigt, Lawrenceville, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/458,835

(22) Filed: Jul. 20, 2006

Related U.S. Application Data
(60) Provisional application No. 60/702,043, filed on Jul. 22, 2005.
(60) Provisional application No. 60/716,301, filed on Sep. 12, 2005.
(60) Provisional application No. 60/726,600, filed on Oct. 14, 2005.

(51) Int. Cl. G06Q 10/00; G06K 9/00

(52) U.S. Cl. 705/2; 382/128

(57) ABSTRACT

The present invention provides a system and method for medication administration monitoring including, in an embodiment, a smart imaging device (smart camera) positioned to monitor a treatment administration area and to provide image representative data of a treatment episode; an image processor, coupled to the smart imaging device, for processing the image representative data to identify medical supplies used during the treatment episode. The system further includes a storage processor for storing, in a record associated with the patient, data concerning the treatment episode comprising, the image representative data, associated data identifying medical supplies, data identifying a patient treated, and a time and date of the treatment episode.

This is a non-provisional application of provisional applications Ser. Nos. 60/702,043, 60/716,301 and 60/726,600 by J. T. Finn et al. filed, Jul. 22, 2005, Sep. 12, 2005 and Oct. 14, 2005 respectively.

### FIELD OF THE INVENTION

The present invention relates to vision based data acquisition, and more particularly, to a vision based data acquisition system and method for use in automatically documenting a medication administration during a patient treatment episode.

### BACKGROUND OF THE INVENTION

Currently, the practice of documenting the administration of a medication to a patient during a surgical procedure is a manual one, and without any real-time clinical checking (e.g. drug allergy checking, drug interaction checking). Manual documentation, as it is presently practiced, is imperfect due to the nature of the medical workflow. The workflow demands the concurrent performance of many actions in rapid fashion. As a result, the accuracy of medications given during a procedure is often impaired because the person who administered the drug relies on memory after the procedure is over to write down what the patient received and at what time. This often leads to lost revenue because of an inefficient method of charge capture. Moreover, since the medication administration is documented after the fact, the medications given cannot be checked for clinical contraindications before they are given to the patient.

Relying on physicians and nurses to administer medications during a surgical procedure is problematic in that physicians and nurses are gowned and masked with sterility being a primary concern. Access to drugs is limited due to the constraints of the operating room setting and the necessary focus on the patient.

Presently, prior to the start of a surgical procedure, medications and supplies are gathered and placed on an operating room tray for the surgery. The medications and supplies are usually charged manually to the patient at this time and then later credited manually, if not used. When a medication is used on a patient during the procedure, someone has to manually record (at the time of administration, if possible) the following details on a piece of paper (called an “intraoperative flow-sheet record” or OR flow-sheet): the medication given, the amount given, the location (IV site) and the time of administration. Two technologies which may be used in this process are bar-code technology and radio-frequency identification (RFID). The proper bar-code or RFID needs to be scanned at the time of administration and the user needs to confirm that it is being given. However, it is often not possible to record drug administration details manually during surgery for the reasons stated above. As a result, manual documentation is performed after the procedure has terminated, relying solely on the recorder's memory of the events that transpired much earlier in time. This is problematic in that it often results in inaccuracies in documentation (omissions, errors, etc.) and the loss of revenue, as stated above. The utilization of bar-coding and RFID technologies is an imperfect solution because it requires additional manipulation of the medication which further interrupts and distracts the doctors and staff performing the procedure.

### SUMMARY OF THE INVENTION

In view of the aforementioned problems and deficiencies of the prior art, the present invention provides, in one aspect, a system and method for medication administration monitoring, the system includes smart camera technology to identify to identify medications in an operating room (OR) during a surgical procedure before the medication is administered.

In another aspect, the present invention provides a mobile station (e.g., crash cart) having built in smart camera technology to identify medications in an operating room (OR) during a surgical procedure before the medication is administered.

A system for providing medication administration monitoring to accomplish the methods disclosed herein may comprise, a smart imaging device (smart camera) positioned to monitor a treatment administration area and to provide image representative data of a treatment episode; an image processor, coupled to the smart imaging device, for processing the image representative data to identify medical supplies used during the treatment episode. The image processor using object recognition and classification processes based on a determination of a similarity metric with data representing predetermined objects. The system further includes a storage processor for storing, in a record associated with the patient, data concerning the treatment episode comprising, the image representative data, associated data identifying medical supplies, data identifying a patient treated, and a time and date of the treatment episode.

### BRIEF DESCRIPTION OF THE DRAWINGS

The present invention is described in more detail in relation to the enclosed drawings, in which:

FIG. 1 is an overview of an exemplary system;

FIG. 2 is an exemplary permanent paper record of the timeline of events for an cardiac code situation, generated by a system of the invention;

FIG. 3 is a sequence diagram illustrating an overview of the method of the invention; and

FIG. 4 shows a process for performing multi-object localization and identification of objects on a procedure tray.

### DEFINITIONS

The definitions provided below are to be applied to their respective terms or phrases as used herein unless the context of a given particular use of a given term or phrase clearly indicates otherwise.

As defined herein—“An Executable Application”—comprises code or machine readable instruction for implementing predetermined functions including those of an operating system, healthcare information system or other information processing system, for example, in response user command or input.

As defined herein—“An executable procedure”—is a segment of code (machine readable instruction), sub-routine, or other distinct section of code or portion of an executable application for performing one or more particular processes and may include performing operations on received input parameters (or in response to received input parameters) and provide resulting output parameters.

As defined herein—“A processor” is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example.

As defined herein—“A display processor or generator”—is a known element comprising electronic circuitry or software or a combination of both for generating display images or portions thereof. A user interface comprises one or more display images enabling user interaction with a processor or other device.

### DESCRIPTION OF PREFERRED EMBODIMENTS

In general, throughout this description, if an item is described as implemented in software, it can equally well be implemented as hardware or a combination of both hardware and software. It is also understood that “data,” as used herein, is either singular or plural as the context requires.

While the disclosed system is described in the context of a hospital setting where drug administration occurs in a high pressure environment or where documentation can be streamlined, it is understood that the principles of the invention are applicable in other settings. The disclosed system may be applied, for example, to the automotive industry by assisting service personnel in the maintenance of automobiles by automatically documenting tasks included in a service procedure.

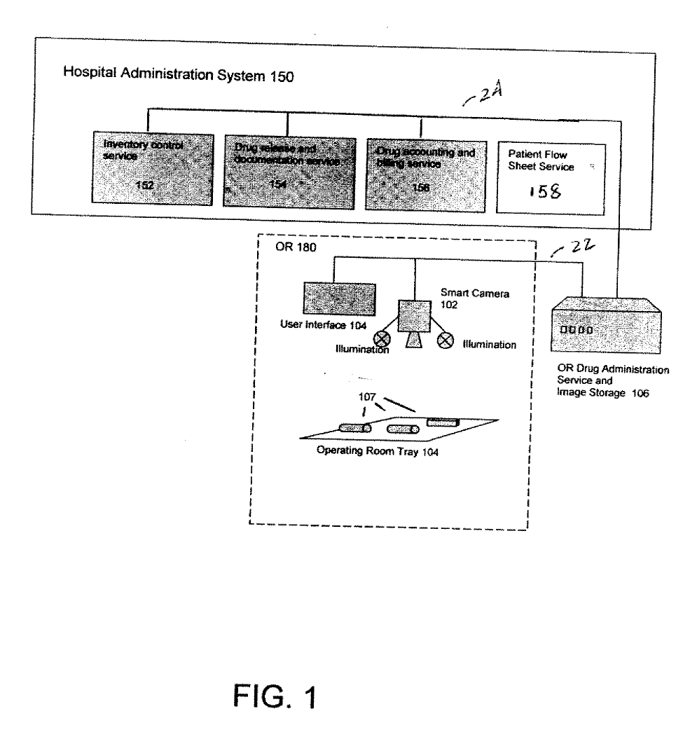

Referring now to FIG. 1, in an exemplary embodiment, system 10 for medication and treatment administration monitoring in an operating room (OR) setting comprises a smart imaging device 102, referred to hereafter as a “smart camera”, a user interface 104, (e.g., display device) and a drug administration service module 106 including a storage processor for storing in a patient record, data concerning a patient treatment episode. The stored data may comprise, for example, image representative data provided by the smart camera 102, associated data identifying medical supplies, data identifying a patient treated, and a time and date of a treatment episode. The drug administration service module 106 manages workflow functions between the smart camera 102 and a hospital information system 150. The hospital information system 150 provides various hospital services, such as an inventory control service 152, a patient specific drug release and documentation service 154, a drug accounting and billing service 156 and a patient flow sheet service 158. The hospital services interact with system 10 in a manner described below. The hospital information system 150 may also involve networks 22 and 24 including Local Area Networks (LANs), Wide Area Networks (WANs) and other dedicated hospital networks or other medical (or other) systems and communication networks.

The smart camera 102, user interface 104 and drug administration service module 106 communicate via networks 22.

Smart camera 102 is mounted above an operating room tray 104 in the operating room (OR) 180 to monitor items 107 on the operating room tray 104, which is an area of high priority where operating room (OR) personnel routinely pick up items 107 to be administered to a patient (not shown). As items 107 are picked up from the operating room tray 104, the smart camera 102 uses image recognition techniques, which are provided within the smart camera 102, to identify the items 107 on the operating room tray 104. Item identification is discussed in greater detail below.

In more complex forms of the invention, the imaged area can also include the operating table including the patient, although the monitoring becomes more difficult.

In other embodiments, the smart camera 102 may be mounted directly to the operating room tray 104 or directly to a so-called “crash cart”, which is a medical mobile station that is typically provided to the care units in a hospital setting. These “crash carts” are used for patients that “crash” in the respective care unit.

The smart camera 102 of the present embodiment is a color, high resolution camera. However, the present invention can be practiced with a black and white camera or a gray tone camera or a camera that detects and/or captures and/or outputs color in certain color frequencies.

The drug administration service module 106 manages workflow functions between the smart camera 102 and a hospital information system 150 via networks 22, 24 (which may be the same or different). In the present embodiment, the drug administration service module 106 is embodied as a software application (i.e., set of instructions or code) for managing workflow functions between the smart camera 102 and the hospital information system 150. In other embodiments, the service module 106 may be embodied as an application running on a server that is part of the hospital information system 150.

The drug administration service module 106 includes a storage processor for storing images generated by the smart camera 102. The stored images effectively constitute a form of video evidence of occurrences that transpire during a patient treatment episode. The images are also uploaded to the hospital information system 150 to be archived. The storage processor provides additional capabilities for temporarily storing non-video data related to a patient's treatment episode, for eventual transfer to the hospital information system 150 to be incorporated into a patient record. The non-video data may include, for example, various activities associated with the patient treatment episode, such as the identification and selection of medications, medical instruments and medical devices located on the operating room tray 104, and time and date of a patient treatment episode.

The smart camera 102 includes an internal image processor to identify, localize, inspect and track items 107 on the operating room tray 104 during a patient treatment episode. The internal image processor operates on internally stored object recognition and classification algorithms (i.e., code) based on a determination of a similarity metric with data representing predetermined objects. For example, to perform object recognition and classification of items 107 on the operating room tray 104, the object images are compared with stored digital representations of items typically employed on an operating room tray 104 during a treatment episode, such as medication medical instruments and medical devices.

The image processing problem presented in the present context of multi object localization, identification and inspection can be divided into two sub-problems. The first sub-problem addresses object localization and identification. This involves the identification of objects 107 and corresponding poses in a given image or image stream. The second sub-problem focuses on object inspection, where given a specific object type and known pose in the image, features such as fill position or medication coding can be extracted. Both aspects involve use of a list of object models and a list of inspection operations for expected objects, Object models are typically generated prior to the system installation and are reinitialized in the case where new object types need to be added.

One aspect of item localization and identification is performance monitoring or estimation of uncertainties. The smart camera 102 internal image processor determines an estimate of uncertainty concerning an identified medical supply (object 107 in FIG. 1) and inhibits identification if the estimate of uncertainty exceeds a pre-determined threshold.

The current state of the art for localization and classification algorithms shows that false alarms and misdetection are not excluded and require special care. In a currently preferred embodiment, to minimize false alarms and misdetections, system 10 (FIG. 1) uses a parametric model to perform object localization and identification. As is well known, a parametric model can be viewed as a compact representation of an object which explicitly describes an item's shape (geometry), surface texture, material properties such as reflectance or transparence and relative motions.

Parametric models are preferred over non-parametric models based on a more complete understanding of a parametric model's limitations as compared with non-parametric models. The non-parametric model also suffers from requiring a larger number of parameters and is derived from a larger image data set containing different views and appearances of the item of interest. Further, the non-parametric model depends on the quality of the training data and cannot be verified by looking at the model.

In an operating room setting, such as the one shown in FIG. 1, OR 180, the identification of medications is performed for documentation purposes to alleviate hospital staff from the burden of recording it manually. Medications administered to a patient during a treatment episode are documented in an operating room flow-sheet, which records both the time of administration and the person administering the medication. As is well known to persons knowledgeable in the medical arts, a flow-sheet is a paper or an electronic form that gathers important data regarding a patient's condition and serves as a reminder of care and a record of whether care expectations have been met. It is mainly used in an acute care facility specifically the operating room, OR and the Intensive Care Unit (ICU). For an operating room setting, the flow-sheet records, at a minimum, any medication given to a patient, vital signs and events. In the present embodiment, it is assumed that system 10 (FIG. 1) interacts with an electronic version of the operating room flow-sheet, which is stored as pail of the hospital information system 150.

In the present embodiment, identification of objects 107 on the operating room tray 104 comprises identifying those objects and corresponding poses in a given image or image stream. Identification is accomplished through the use of well known advanced image recognition and analysis software, stored in the smart camera 102, as discussed above.

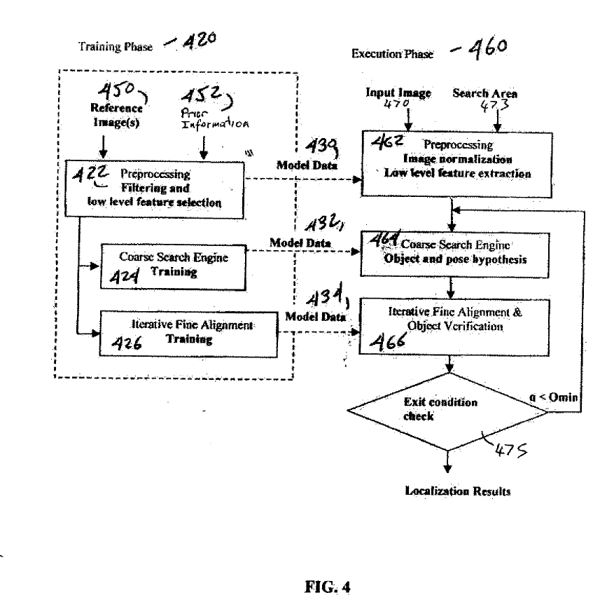

FIG. 4 shows a process 400 for performing multi-object localization and identification of objects 107 on the procedure tray 104. The process is divided into two phases, a training phase 420 and an execution phase 460. The object of the training phase 420 is to learn, for a set of reference objects, the object's 107 characteristics, such as, for example, the object's size, position, color, degree of fill in a syringe (e.g., quarter full, half full and so on). Information about the object derived from training phase 420 is used as input to an execution phase algorithm (i.e., hypothesis based) for determining a procedure tray object's characteristics and pose, as used during a patient treatment episode.

Object models, referred to herein as model data 430, 432, 434 in FIG. 4, is typically generated prior to system installation and needs to be reinitialized whenever a new object type needs to be added (e.g., new syringe shape, drug bottle shape, new medical device). As shown, the generated model data 430, 432, 434 is supplied as respective inputs to an execution phase 460. Generation of the model data 430 during the training phase 420, involves receiving as input, one or more reference images 450 and prior information 452 e.g., previously accumulated object specific data comprising, for example, object image data reflecting different poses, shapes, colors, shading, dimensions etc. of an object and other characteristics and information. Specifically, the filtering and low level feature selection module 422, receives one or more reference images 450 and prior information 452 as input, preprocesses the data and outputs low level model data 430 to a corresponding preprocessing, filtering and low level feature selection module 462, as part of the execution phase 460. The preprocessed data is also output from the preprocessing, filtering and low level feature selection module 422 to a coarse search engine training module 424 and an iterative fine alignment training module 426. Each of these modules 424, 426 outputs respective model data 432, 434.

With reference now to the execution phase 460, the object models, referred to herein as model data 430, 432, 434, is generated as output from the three training phase 420 modules 462, 464, 466, respectively. This model data 430, 432, 434 describes various object model characteristics and poses for a set of reference images and poses. The model data 430, 432, 434 is supplied as input to corresponding execution phase modules 462, 464, 466 to facilitate identification of one or more inputs image 480 object characteristics and poses. Specifically, an input image 470, search area determination data 473 and model data 430, 432, 434 are supplied as inputs at various stages of 462, 464, 466 of the execution phase 466 to predict (hypothesis) a similarity metric concerning an object on an operating room tray 104 during a patient treatment episode. if the similarity metric meets a predetermined level indicating a corresponding likelihood an object on tray 104 is correctly identified, the process exits. If the similarity metric fails to indicate a sufficiently close match 475, modules 462, 464 and 466 re-analyze the input data to derive a new similarity metric. The process repeats until failure is declared or the object is identified as having a predetermined level similarity with a known object.

This identification function triggers clinical medication checking such as drug allergy alerts and IV incompatibility checks, drug interaction checking, automatic recording of dose given and materials used, initiates charge capture and billing, as well as triggers re-ordering of drugs from the hospital pharmacy, as discussed in greater detail below. Additionally, the medication given is documented in an OR flow-sheet with the time of administration and the administrator of the medication.

Medications are identified by the smart camera 102 in a number of ways, including, without limitation, identifying the medication's name, the medication's color, the location of a medication in a medication preparation area, an identifier label associated with the medication, a medication volume in a syringe, a medication pill size, a syringe plunger location, before and after administration volumes in a syringe, a color coded label on the syringe identifying the drawn up medication and a medication's form and size.

In addition to providing capabilities for identifying the items 107 on the operating room tray 104, the smart camera 102 localizes the items lying on the operating room tray 104. As stated above, identification of a medication type may be made in response to an identified location of a medication in a medication preparation area.

When system 10 (FIG. 1) identifies that an item has been picked up from the operating room tray 104 during a patient treatment procedure, if the item is a medication, system 10 performs an early clinical check through the patient specific drug release and documentation service 154, which is a part of a hospital information system 150. The clinical check preferably includes: drug-allergy checking, drug-drug interaction checking, therapeutic duplicate checking, and generic duplication checking. The patient specific drug release and documentation service 154 utilizes a clinical database (not shown) to perform the necessary checking. Commonly used, clinical databases include, for example, NDDF and NDB, which are well known.

In the case where the clinical check results in an alert, system 10 (FIG. 1) may display the detected alert to a user, via the user interface 104 (display device) and optionally display limited drug information such as, for example, dosage, indications, or category (e.g., inotropic, vasodilator), IV administration information, patient monitoring information as well as any IV incompatibilities with other IV's that the patient may be receiving at the time. The administration is integrated with the patient's electronic medical record (EMAR), stored by the hospital information system 150 and the item is added to the patient's OR flow-sheet, as discussed above.

System 10 provides item tracking capabilities for determining medication usage during a treatment episode by recognizing, for an item 107 on the operating room tray 104 like a syringe, the syringe type (e.g., 1 cc, 5 cc, 20 cc, etc.) the initial volume contained in the syringe and the remaining volume after administration to the patient. System 10 can also determine whether a medication is drawn up into a syringe by the proximity and position of the vial to the syringe and the drawing back of the plunger.

Item tracking capabilities provided by system 10 also include an automatic recordation of the date and time of administration by the drug administration service module 106 and automatically passes along a charge for the product to the hospital a drug accounting and billing service 156 which is in turn coupled to the hospital inventory control service 152 to generate reordering procedures to replenish supplies.

Item tracking further includes adding the administered item (medication) to the patient's OR flow-sheet with the required information.

In one embodiment, the smart camera 102 may be equipped with audio capabilities. An audio recording commences when a predefined verbal command, such as, for example, “audio on”, is spoken and interpreted by a speech recognition engine in the smart camera 102. The speech recognition engine is configured to permit certain authorized individuals to initiate an audio recording. During the audio recording session, facts are recorded that become part of the permanent record for the event. The recording may optionally be transcribed to become part of the permanent record for the event as and adjunct to the video recording.

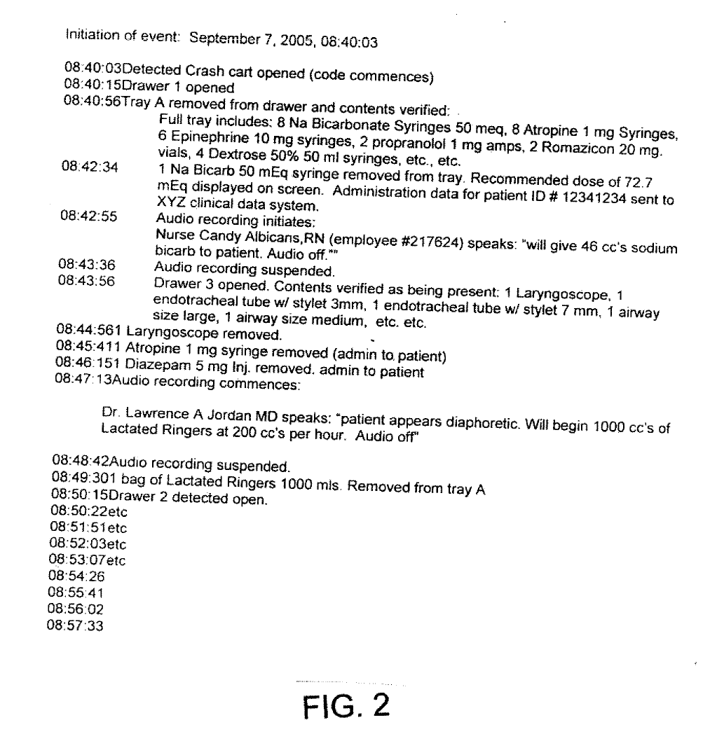

By way of example and not limitation, referring now to FIG. 2, there is shown an exemplary permanent paper record of the timeline of events for an exemplary cardiac code situation. The paper record includes a transcription of the audio and video events. These events are visually/orally recorded by the smart camera 102 during a patient treatment episode. The data is output to the drug administration service 106 which, may store the data temporarily, or otherwise transfer the data to the hospital information system 150, for incorporation into the patient's OR flow-sheet.

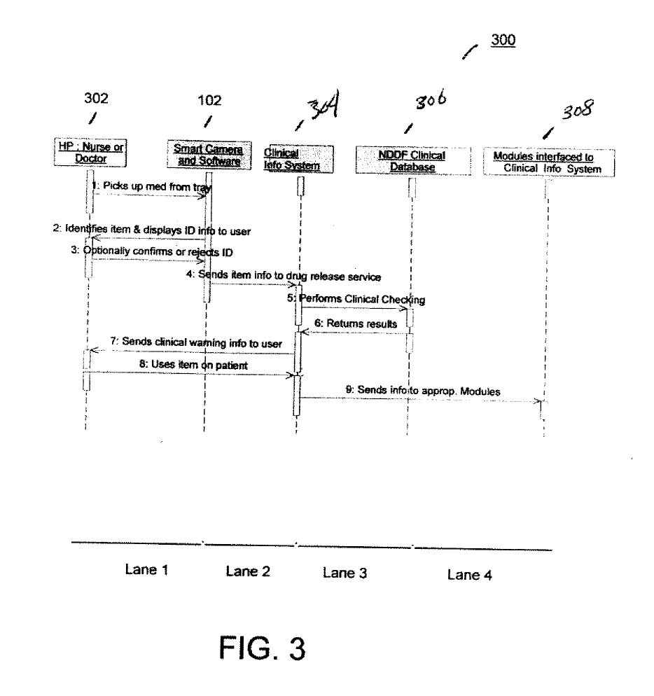

By way of example, FIG. 3 is a sequence diagram 300 illustrating in detail a process, according to invention principles, for automated real-time documentation of medication administration used in system 10 (FIG. 1).

The sequence diagram 300 is composed of four lanes of messaging traffic, as shown. A first lane of traffic of the sequence diagram 300, lane 1, illustrates operations that occur between the smart camera 102 and healthcare professionals (HP) 320 in the operating room (OR) 180 (FIG. 1).

At step 1, a healthcare professional (HP) 320, picks up a medication (object 107) from the operating room tray 104 in the OR 180.

At step 2, the smart camera 102 records the action of picking up the medication and processes the received images to identify the particular medication that has been picked up from the operating room tray 104, using previously described techniques of identification, localization and tracking. As stated above, identification is accomplished in the smart camera 102 through the use of advanced image recognition and analysis software stored in the smart camera 102. Identification of the medication at this step includes identifying at least the selected medication's name, strength and volume. It is appreciated that the actions of recording the images and processing those images are performed internal to the imaging device 102.

At step 3, the healthcare professional (HP) 302, optionally confirms or rejects the result of the identification procedure performed by the smart camera 102. In particular, at this step, identification information is displayed to the HP 320 via the user interface 104 (display device) in the OR 180 to give the HP 320 an opportunity to reject a false identification. In the present embodiment, if the HP approves the medication identification, then no further action is required and confirmation is thereby implicitly conferred.

At step 4, the identified and confirmed medication is then transmitted from the smart camera 102 to the drug accounting and billing service 154 of the hospital information system 150. This is shown at the second lane of traffic of the sequence diagram 300, lane 2.

At step 5, a clinical check of the identified item is performed. This clinical check preferably includes: drug-allergy checking, drug-drug interaction checking, therapeutic duplicate checking, and generic duplication checking. The identification information is transmitted from the Clinical information system 304 to the NDDF clinical database 306. This is shown at the third lane of traffic of the sequence diagram 300 for illustrating operations that occur between the drug accounting and billing service 154 of the hospital information system 150 (FIG. 1) and the NDDF Clinical database 340, for example. The NDDF Clinical database 340 is merely representative of the type of database to be accessed in this regard.

At step 6, the results of the clinical check are returned from the NDDF Clinical database 340 to the drug accounting and billing service 154 of the hospital information system 150. This is also shown at the third lane of traffic of the sequence diagram 300

At step 7, in the case where the clinical check performed at step 5, results in a warning or alert, the warning is transmitted back to the HP 302 to the user interface 104 via the drug administration service 106. For example, the alert may indicate to the HP 302, via user interface 104, that there is a maximum dosage restriction due to the history of the patient or that there is a problem with the particular medication, due to the history of the patient. The HP 302 may decide to do some verification of the alert, which is input via user interface 104 and incorporated into the patient's OR flow-sheet via drug administration service 106.

At step 8, in the case where the clinical check performed at step 5, results in no warning or alert, the medication is administered to the patient.

At step 9, information is transmitted into appropriate modules 308 interfaced to the clinical information system 304. Modules 308 are updated. This comprises update of inventory, billing and financial records, patient medical record, a patient care plan, scheduling information and other patient specific records in hospital financial and clinical data processing systems associated with system 10.

In another embodiment of the present invention, the smart camera 102 may be mounted directly to a so-called “crash cart”, which is a medical mobile station that is typically provided to each care unit in a hospital setting. Typically, each care unit has one or more crash carts that are used for any patient that “crashes” in that unit (e.g., a cardiopulmionary arrest). The crash cart is on wheels so that it can be quickly brought to the patient's bedside and the supplies needed are readily available. The resuscitative process that occurs during so-called “code” situations happens at rapid speed. It is therefore critical to record what occurs and when it occurs. However, there is no one dedicated person available to write down everything that happens at the exact time it happens, and it is often left up to the people who were involved in the code to remember everything that went on and when it occurred retrospectively and from memory or their cursory notes. As discussed above, manual systems of documentation are inaccurate as they are dependent upon the recollection of everyone performing the resuscitation. The present invention addresses these concerns by providing a mobile treatment station for treatment administration monitoring that advantageously employs a smart camera 102 (see FIG. 1) mounted on the mobile treatment station to identify items used by a healthcare worker, as they are removed from predetermined locations in the mobile treatment station. As is well known, mobile stations in a hospital are stocked with identical items which are typically stacked in the same location in the hospital's mobile station. This standardization facilitates localization and identification of items (e.g., medical supplies) as they are removed from predetermined locations in the mobile treatment station.

It is to be appreciated that the mobile station of the present invention provides the features of system 10 (FIG. 1). For example, the mobile station provides accurate and legally compliant documentation records of medications and supplies used during a “code” situation, documenting the sequence of events as well as the date and time of administration, proper identification of a medication or device used during a procedure, dosage information during a “code” situation, automatic capture of charges associated with the items used and inventory control of the supplies used.

The smart camera 102 may be equipped with audio capabilities. An audio recording commences when a predefined verbal command, such as, for example, “audio on”, is spoken and interpreted by a speech recognition engine in the smart camera 102. The speech recognition engine is configured to permit certain authorized individuals to initiate an audio recording. During the audio recording session, facts are recorded that become part of the permanent record for the event. The recording may optionally be transcribed to become part of the permanent record for the event as and adjunct to the video recording.

It is apparent that the present invention provides numerous advantages over the prior art. A primary advantage provided by the invention is the ability to automatically document drug administration details in an operating room setting during a treatment episode without the need for scanning, thereby removing the need for physicians and nurses to perform time-consuming administration tasks which detract from the success of the treatment episode.

Other advantages provided by the invention include, increased operating room workflow efficiency, by connecting the system to a hospital pharmacy workflow to trigger inventory control operations, resulting in increased precision in the audit trail to which drug has been administered and performing real-time, online clinical checking of medications to be administered. The clinical checking may include, for example, drug allergy checking, drug interaction checking, drug incompatibility checking, drug dosage checking, etc., thus increasing patient safety. The clinical checking advantageously provides the clinician with any applicable alerts or warnings before the drug is administered to the patient. The patient benefits by allowing the medical staff to exclusively focus on care giving.

In addition to those benefits discussed above, a number of economic benefits are derived, including, improved billing accuracy and increased revenue for an acute care facility and the identification and recording of drug usage information which is automatically routed to the hospital's financial system.

It will be understood that various changes in the details, materials, and arrangements of the parts which have been described and illustrated above in order to explain the nature of this invention may be made by those skilled in the art without departing from the principle and scope of the invention as recited in the following claims.

1. A system for treatment administration monitoring, comprising,
a video camera positioned for monitoring a treatment administration area and providing image representative data of a treatment episode;
an image processor for processing said image representative data to identify medical supplies used during said treatment episode using object recognition and classification based on determination of a similarity metric with data representing predetermined objects; and
a storage processor for storing, in a record associated with said patient, data concerning said treatment episode comprising, said image representative data, associated data identifying medical supplies, data identifying a patient treated, and a time and date of said treatment episode.

2. A system according to claim 1, wherein
said medical supplies include at least one of, (a) medication, (b) medical instruments and (e) medical devices, and
said image processor processes said image representative data to identify a medication type in response to an identified medication form and size.

3. A system according to claim 1, wherein
said image processor identifies said medication type in response to an identified location of a medication in said medication preparation area, and
said image processor determines an estimate of uncertainty concerning an identified medical supply and inhibits identification if said estimate of uncertainty exceeds a predetermined threshold.

4. A system according to claim 1, wherein
said image processor identifies said medication type in response to an identified identifier label associated with said medication.

5. A system according to claim 1, wherein
said image processor identifies a quantity of medication administered to said patient in response to at least one of, (a) an identified medication volume in a syringe and (b) medication pill size.

6. A system according to claim 5, wherein
said image processor identifies a quantity of mediation administered to said patient in response to at least one of, (a) a syringe plunger location and (b) before administration and after administration volumes in said syringe.

7. A system according to claim 1, wherein
said image processor identifies a quantity of medication administered to said patient in response to at least one of, (a) an identified medication volume in a syringe and (b) medication pill size.

8. A system according to claim 1, including
a medication administration processor for using data indicating an identified medication type and information indicating another medication also prescribed for said patient, derived from a patient record, to perform at least one of, (a) a medication interaction check, (b) a patient allergy check and (c) a check for whether a medication is a duplicate of another medication also prescribed for said patient.

9. A system according to claim 1, including
a billing processor for initiating generation of a record for use in billing said patient for use of said medical supplies.

10. A system according to claim 1, including
an inventory processor for initiating generation of a record for use in re-ordering supplies to replace said identified medical supplies.

11. A system for medication administration monitoring, comprising:
a video camera positioned for monitoring a medication preparation area and providing image representative data;
an image processor for processing said image representative data to identify a medication type in response to an identified medication form and size, and
a data processor for storing data indicating said identified medication type and time of administration to a patient in a record associated with said patient.

12. A system according to claim 11, wherein
said image processor identifies said medication type in response to an identified medication color.

13. A system according to claim 11, wherein
said image processor identifies said medication type in response to an identified location of a medication in said medication preparation area.

14. A system according to claim 11, wherein
said image processor identifies said medication type in response to an identified identifier label associated with said medication.

15. A system according to claim 11, wherein
said image processor identifies a quantity of medication administered to said patient in response to at least one of, (a) an identified medication volume in a syringe and (b) medication pill size.

16. A system according to claim 11, wherein
said image processor identifies a quantity of medication administered to said patient in response to at least one of, (a) a syringe plunger location and (b) before administration and after administration volumes in said syringe.

17. A system according to claim 11, including
a medication administration processor for using said identified medication type and information indicating another medication also prescribed for said patient to perform a medication interaction check.

18. A system according to claim 11, including
a medication administration processor for using said identified medication type to perform an allergy check.

19. A system according to claim 11, including a medication administration processor for using said identified medication type to determine if a medication is a duplicate of another medication also prescribed for said patient.

20. A system according to claim 11 including
a billing processor for initiating generation of a record for use in billing said patient for administration of said identified medication type.

21. A mobile treatment station for treatment administration monitoring comprising:
a video camera positioned for monitoring a treatment administration area and providing image representative data of a treatment episode;
an image processor for processing said image representative data to identify,
a medical supplies used during said treatment episode, and
a patient treated during said treatment episode; and
a storage processor for storing, in a record associated with said image representative data and a time and date of said treatment episode.

22. A mobile treatment station according to claim 21, including
an audio processor for capturing audio during said treatment episode concerning said treatment episode for storage in a patient record.

23. A system for treatment administration monitoring, comprising,
a video camera positioned for monitoring a treatment administration area and providing image representative data of a treatment episode;
an image processor for processing said image representative data to identify,
a medical supplies used during said treatment episode, and
a patient treated during said treatment episode; and
a storage processor for storing, in a record associated with said patient, data concerning said treatment episode comprising, said image representative data, associated data identifying medical supplies, data identifying a patient treated, and a time and date of said treatment episode.

24. A system according to claim 23, wherein
said medical supplies include at least one of, (a) medication, (b) medical instruments and (c) medical devices.

25. A system according to claim 23, wherein
said image processor identifies said medication type in response to an identified location of a medication in said medication preparation area.

26. A system according to claim 23, wherein
said image processor identifies said medication type in response to an identified identifier label associated with said medication.

27. A system according to claim 23, wherein
said image processor identifies a quantity of medication administered to said patient in response to at least one of, (a) an identified medication volume in a syringe and (b) medication pill size.

28. A system according to claim 23, wherein
said image processor identifies a quantity of mediation administered to said patient in response to at least one of, (a) a syringe plunger location and (b) before administration and after administration volumes in said syringe.

29. A system according to claim 23, wherein
said image processor identifies a quantity of medication administered to said patient in response to at least one of, (a) an identified medication volume in a syringe and (b) medication pill size.
